(19) United States
(12) Patent Application Publication
(10) Pub. No.: US 2004/0012575 A1
(43) Pub. Date: Jan. 22, 2004

(54) Storage and removal system for pointer utilized with an electronic device

(76) Inventors: Steven S. Homer, Tomball, TX (US); Paul J. Doczy, Cypress, TX (US); Mark C. Solomon, Cypress, TX (US)

Correspondence Address: Robert A. Van Someren, Fletcher, Yoder & Van Someren, P.O. Box 692289, Houston, TX, 77269-2289, US

(21) Appl. No.: 10/200,717

(22) Filed: Jul. 22, 2002

(51) Int. Cl. G09G 5/00

(52) U.S. Cl. 345/179

(57) ABSTRACT

A system having an electronic device with a pointing mechanism by which a user interacts with the electronic device. The system further comprises a retention mechanism that is used to securely retain the pointer mechanism with the electronic device, while permitting a user to readily remove the pointer mechanism when needed.

### FIELD OF THE INVENTION

The present invention relates generally to electronic devices that utilize a physical pointer to interact with the device, and particularly to a storage and ejection system for such pointers.

### BACKGROUND OF THE INVENTION

A variety of electronic computing devices, such as PDAs, utilize a pointer to interact with the device. For example, the device may have a display screen designed to respond to the physical touch of a mechanical pointer. Typically, the screen displays a variety of icons or other indicators that may be touched or lightly pressed with the pointer. When pressed in specific areas, the electronic device functions in a desired way. The pointer may be used, for instance, to rapidly move through different menus, to select items within a displayed menu to select or write alphanumeric symbols, etc.

During storage, the pointer is clipped to the device housing or slid into an appropriate opening formed in the device housing. However, such conventional storage techniques can cause difficulty in removing the pointer and/or difficulty in maintaining the pointer in its storage position until use. This can become an even greater problem when the size and mass of the pointer is increased.

### SUMMARY OF THE INVENTION

The present invention relates generally to a technique that facilitates storage and removal of a variety of pointing mechanisms utilized with various electronic devices. The technique utilizes a double action system that permits the pointer mechanism to be moved into a storage location and then selectively pressed to release the pointer mechanism to a removal position. The storage and removal technique can be utilized with a variety of electronic devices, such as portable computers, tablet PCs, PDAs and other electronic devices designed to interface with a pointer mechanism. The technique is particularly amenable for use with heavier and/or larger pointer mechanisms, such as an electronic pointing device.

### BRIEF DESCRIPTION OF THE DRAWINGS

The invention will hereafter be described with reference to the accompanying drawings, wherein like reference numerals denote like elements, and:

FIG. 1 is a perspective view of an exemplary electronic device and pointer mechanism, according to one embodiment of the present invention;

FIG. 2 is a front elevational view of the electronic device of FIG. 1;

FIG. 3 is a cross-sectional view of an exemplary pointer mechanism, taken generally along the axis of the pointer mechanism;

FIG. 4 is another cross-sectional view of the pointer mechanism similar to that of FIG. 4 but showing additional components;

FIG. 5 is a perspective view of the device illustrated in FIG. 1 combined with an exemplary keyboard;

FIG. 6 is a cross-sectional view of an exemplary pointer mechanism mounted in a retention mechanism of the electronic device, illustrated in FIG. 1;

FIG. 7 is a cross-sectional view similar to that of FIG. 6 but showing the retention mechanism in a release position;

FIG. 8 is a cross-sectional view similar to FIG. 6 but showing the pointer mechanism in a depressed position; and

FIG. 9 is a cross-sectional view of an alternate embodiment of the retention mechanism.

### DETAILED DESCRIPTION OF EXEMPLARY EMBODIMENTS

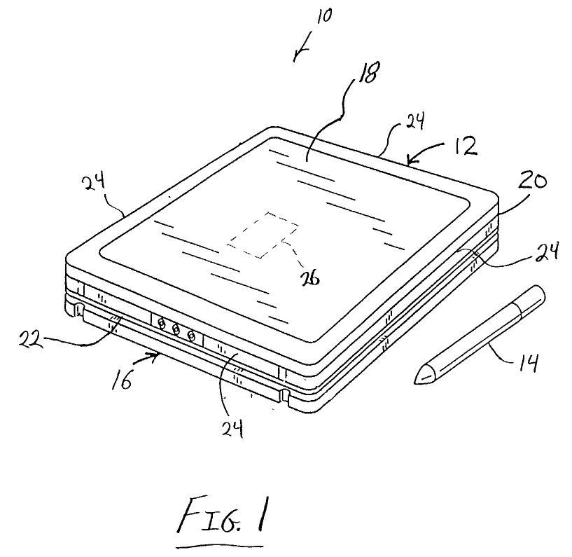

Referring generally to FIG. 1, an exemplary system 10 is illustrated in which an electronic device 12 is designed to interface with a pointer mechanism 14. Electronic device 12 may be of a variety of types, including computing devices, such as portable computers, personal digital assistants (PDAs), and tablet PCs.

In the embodiment specifically illustrated in FIG. 1, electronic device 12 comprises a tablet computing device having a detachable keyboard 16 and a display 18. In this embodiment, display 18 is mounted in a device housing 20, although display 18 can be designed as separable or with a pivotable connection to housing 20. Opposite display 18, housing 20 comprises a bottom 22 and a plurality of side walls 24.

Depending on the design of electronic device 12, pointer mechanism 14 may be a simple mechanical device. Alternatively, pointer mechanism 14 may be an intelligent device, such as an electronic pointer device, e.g. a battery powered digitizer pen.

Electronic device 12 typically has a variety of internal components, such as a microprocessor 26. Other internal components (not shown) can include a motherboard, volatile and non-volatile memory (e.g. a hard drive RAM, ROM, flash memory, cache memory, etc.), network circuitry (e.g. a modem, a network card, etc.), wireless communication circuitry (e.g. IR, RF, optical, blue tooth, and other technologies), input/output ports, audio/video circuitry, and various other circuitry, components, and component receptacles/bays. For example, the device may comprise wireless communication circuitry, such as RF circuitry, that allow a user to interact with electronic device 12 via detachable keyboard 16 while keyboard 16 is at a remote location.

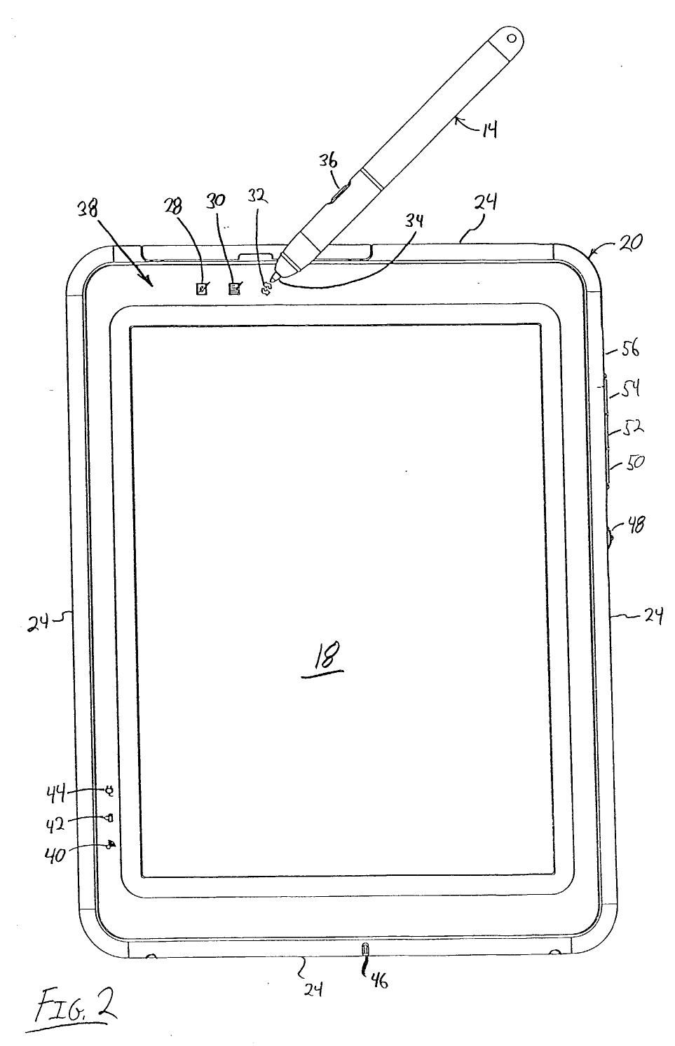

As illustrated in FIG. 2, pointer mechanism 14 may be in the form of a battery powered digitizer pen. In this embodiment, pointer mechanism 14 is designed to interact with various digitizer-activated buttons 28, 30 and 32. As illustrated, pointer mechanism 14 comprises a tip 34 and one or more buttons, such as a select button 36, to facilitate user interaction with the digitizer-activated buttons 28, 30 and 32. Typically, the digitizer pen 14 interacts with a digitizer panel 38 that may be disposed below, within or integral with the display 18.

In this particular example, pointer mechanism 14 interacts with the digitizer panel 38 throughout the dimensions of the display 18 for coordination, selection, writing and other user-interaction via information provided on display 18. The pointer mechanism 14 also is utilized with a variety of buttons/icons 28, 30 and 32 to perform various selected functions.

The digitizer panel 38 and the digitizing pointer 14 may comprise any suitable digitizer technology, such as electron field, ultrasonic, radio frequency, infrared, electrostatic, electromagnetic and other existing, emerging or future technologies. The digitizer panel 38 and the digitizing pointer 14 may operate by one-way or two-way signal transmissions, in either direction, between the digitizer panel 38 and the digitizing pointer 14.

For example, in one embodiment, the digitizing pointer 14 transmits a wireless signal which is sensed by the digitizer panel 38 to coordinate the location of the digitizing pointer 14. The digitizing pointer 14 also may transmit one or more secondary signals to trigger a select function. For example, a click of the tip 34 or select button 36 may transmit a secondary signal able to trigger a desired function.

The digitizer-activated buttons, 28, 30 and 32 are provided in a peripheral region, for example, of the digitizer panel 38, which has active button regions defined for each of the buttons 28, 30 and 32. Each of these active regions is associated with a desired hardware/software function, such as a default or user-defined function. The digitizer-activated buttons 28, 30 and 32 also may comprise indicators, such as LEDs, that are illuminated upon triggering or close proximity of the digitizing pointer 14. For example, an LED associated with one of the digitizer-activated buttons may light up when tip 34 is near the particular digitizer-activated button. Depending on the specific design of electronic device 12 and pointer mechanism 14, buttons 28, 30 and 32 may be activated when tip 34 is at a desired proximity with an associated button or when the tip 34 contacts the defined region associated with a given digitizer-activated button.

Electronic device 12 may incorporate a wide range of features and functionality. For example, the electronic device 12 may include one or more status indicators 40, 42 and 44. The status indicators may comprise icons illuminated by LEDs that correspond to desired devices. For example, the status indicators may correspond to wireless activity, an ac or dc power source, a lower battery level, network connectivity, a system error, processor activity, or any other desired status or activity. The device also may incorporate, for example, a microphone 46 and a jog dial 48. Jog dial 48 is used to scroll through a software menu, pages of text or other displayed information. Additionally, various functional buttons 50, 52, 54 and 56 may be designed to provide default hardware or software functions by which a user may program the device to perform desired hardware or software tasks. For example, the functional buttons may operate as an ESC key, a TAB key, a CRL-ALT-DEL key combination, a RETURN key, a MOUSE key or other standard or specialized keys. These are just a few examples of the types of functionality and physical forms available for electronic device 12.

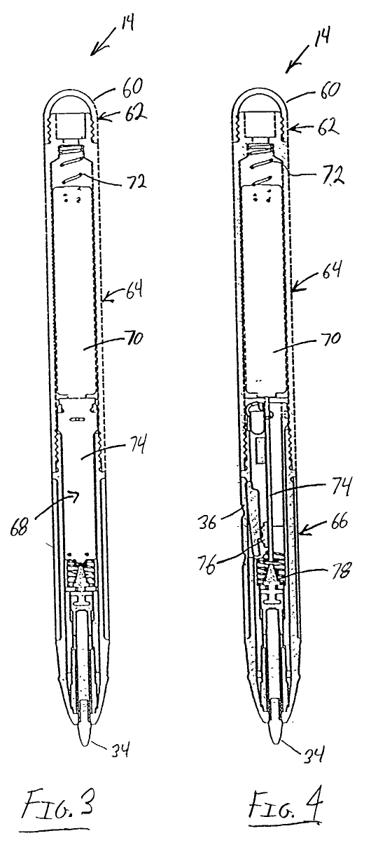

A variety of pointer mechanisms 14 can be utilized with electronic device 12 depending on the form and functionality of the device. For example, pointer mechanism 14 may be a simple mechanical device with no electronics. However, the pointer retention mechanism described below is particularly well suited to larger and/or heavier pointers, such as the electronic pointer mechanism illustrated in FIGS. 3 and 4. In this particular example, pointer mechanism 14 is a digitizing pointing device comprising an elongated housing 60 having a threaded end cap 62, a threaded battery section 64 coupled to the cap 62, and an electronic section 66 coupled to the battery section 64. Electronics section 66 comprises electronic circuitry 68 (see FIG. 3) powered by a battery 70 that is biased against electronic circuitry 68 by a spring 72. In the specific example illustrated, electronic circuitry 68 is at least partially disposed on a printed circuit board 74 having digitizing communications circuitry, a switch 76 that cooperates with the select button 36 and a spring loaded switch 78 that maintains a bias against tip 34.

In this exemplary embodiment, the pointer mechanism 14 generates a signal that is received and processed by digitizer panel 38. For example, this type of pointer mechanism may be a digitizer pen such as those produced by FinePoint Innovations, Inc. of Tempe Ariz.

In operation, the signal transmitted from the digitizing pointing device identifies the location of the tip 34 relative to the display 18 (and subsurface digitizer panel 38), thereby facilitating pointer movement and drawing functions on the display screen. Such a digitizing pointing device also may be used to select items, to interact with system software, to activate virtual buttons on the screen, to activate digitizer buttons or to perform a variety of other functions. For example, one or more special signals may be transmitted from the digitizing pen upon activation of switch 76 via select button 36 or by spring loaded switch 78 via tip 34. Additionally, although the specific digitizing pointing device is described as a signal-generating device, the signal also can be generated in the digitizer panel 38 as opposed to the digitizing pointing device.

As discussed above, this particular pointer mechanism is exemplary only. A variety of pointer mechanisms ranging from the simple mechanical (no electronics) to a variety of sophisticated electronic pointer mechanisms can be utilized with the pointer storage and release mechanism described herein.

Referring generally to FIG. 5, system 10 is illustrated with detachable keyboard 16 detached from housing 20. As illustrated, this exemplary electronic device utilizes a pair of prongs 80 that extend from detachable keyboard 16 for receipt within housing 20 of electronic device 12. Additionally, housing 20 comprises an opening 82 for receiving pointer mechanism 14. Thus, when pointer mechanism 14 is not being used, it is inserted into opening 82 and securely retained within housing 20 of electronic device 12.

To remove pointer mechanism 14, a user simply presses on the slightly extended end. This inward movement of pointer mechanism 14 effectively releases the pointer mechanism and allows it to move to a slightly extended position. In this extended position, the outward end of pointer mechanism 14 is readily grasped by a user who can then simply pull pointer mechanism 14 from opening 82. In the embodiment illustrated, opening 82 is formed near a corner of housing 20 proximate a power button 84. However, opening 82 may be formed at a variety of locations along sidewalls 24 or in or along other portions of housing 20 depending on the overall design of electronic device 12.

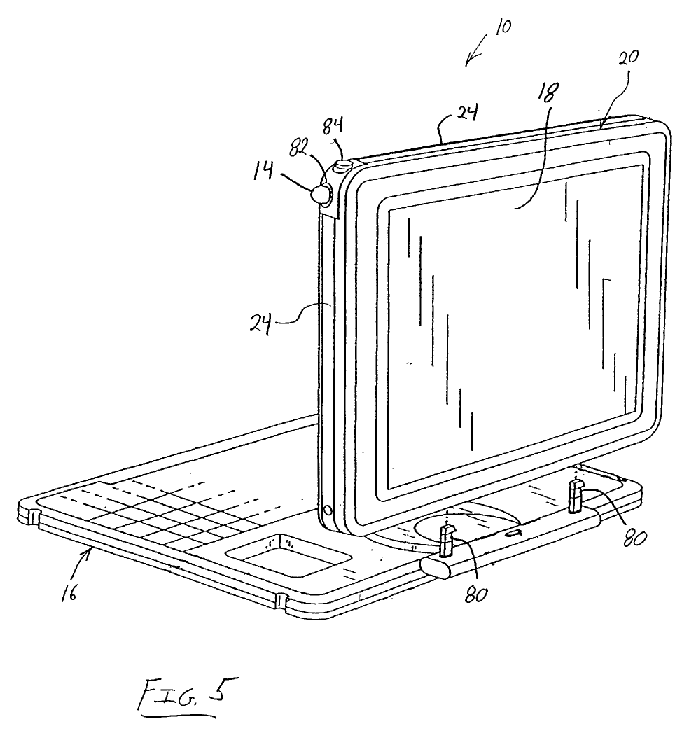

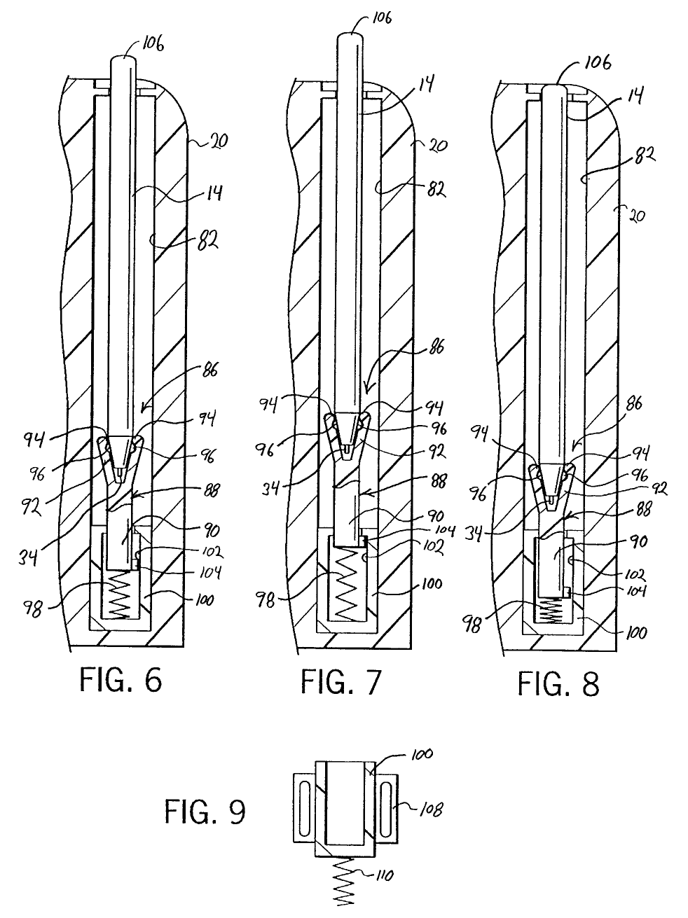

Referring generally to FIGS. 6-8, a pointer retention mechanism 86 is illustrated. Pointer retention mechanism 86 comprises a holder 88 having a sliding member 90 and a pointer mechanism retainer 92. Retainer 92 is designed to fit around the lead end of pointer mechanism 14 and resistively hold pointer mechanism 14. For example, retainer 92 may incorporate mechanical features 94, such as retainer catches that interact with corresponding features, e.g. catches 96, disposed on pointer mechanism 14. These features resist removal of pointer mechanism 14 from holder 88 until a user applies a sufficient tensile force to pointer mechanism 14.

While secured in holder 88, pointer mechanism 14 and holder 88 may be moved between a storage position, as illustrated in FIG. 6, and a release position, as illustrated in FIG. 7. Holder 88 is biased towards the release position by, for example, a spring member 98. The exemplary spring member 98 is disposed in a sleeve 100 sized to slidably receive sliding member 90 of holder 88. Sleeve 100 includes an internal retention feature 102, such as a catch that can be recessed or extending. The retention feature 102 is designed to interact with a corresponding feature 104 on sliding member 90 of holder 88 to resistively maintain holder 88 at the storage position. However, upon pressing pointer mechanism 14 inwardly into housing 20 (as illustrated in FIG. 8) and then releasing the pointer mechanism, the spring member 98 moves feature 104 past retention feature 102. The spring member 98 continues to bias holder 88 to the release position, as illustrated best in FIG. 7. In the release position, pointer mechanism 14 extends a greater distance from housing 20, permitting a user to readily grasp the pointer mechanism and pull it free from retainer 92 of holder 88.

In the embodiment illustrated in FIGS. 6-8, sleeve 100 is of sufficient length to permit movement of pointer mechanism 14 into opening 82 of housing 20 until the distal end 106 of pointer mechanism 14 is flush with housing 20. This prevents breakage or other damage if distal end 106 is impacted due to droppage or impact with other objects. Alternatively or in addition, sleeve 100 may be mounted within an appropriate carriage 108, as illustrated best in FIG. 9. In this embodiment, sleeve 100 either slides within carriage 108 (see FIG. 9) or moves with carriage 108 as it slides within an appropriately formed slide area (not shown) of housing 20. With either design, slide 100 is allowed to move downwardly against a spring member 110 if pointer mechanism 14 and holder 88 are pressed into housing 20 a sufficient distance. Upon removal of the force, spring member 110 returns sleeve 100 and holder 88 to the normal storage position.

Thus, retention mechanism 86 provides a secure technique for holding a variety of pointer mechanisms within a protected portion of electronic device housing 20. The exemplary mechanism allows the pointer mechanism to be over inserted into the housing and also permits selected movement of the pointer mechanism to a release position without allowing the pointer to freely slide or fall from electronic device 20. In operation, a user simply depresses distal end 106 of pointer mechanism 14, and upon release of the distal end, retention mechanism 86 moves pointer mechanism 14 to the release position (see FIG. 7). However, at this release position, retainer 92 resistively holds the pointer mechanism to prevent inadvertent removal. Accordingly, a user can simply apply a tensile force to the extended distal end 106 to completely remove pointer mechanism from holder 88.

It will be understood that the foregoing description is of exemplary embodiments of this invention, and that the invention is not limited to the specific forms shown. For example, a variety of electronic devices and pointer mechanisms may be utilized; the retention mechanism can be mounted at locations within and on the electronic device housing; the spring members are representative of a variety of biasing mechanisms; and the form and arrangement of components can vary according to application. These and other modifications may be made in the design and arrangement of the elements without departing from the scope of the invention as expressed in the appended claims.

What is claimed is:

1. A pointer system, comprising:
an electronic device having a housing with an opening;
a pointer sized for receipt in the opening; and
a pointer retention mechanism having a holder to receive the pointer and resistively hold the pointer, wherein the holder may be moved selectively between a pointer storage location and a pointer release location.

2. The pointer system as recited in claim 1, wherein the holder comprises a catch positioned to engage a corresponding catch feature of the pointer when the pointer is inserted into the holder.

3. The pointer system as recited in claim 2, wherein the holder is spring-biased toward the pointer release location.

4. The pointer system as recited in claim 3, wherein the electronic device comprises a personal computer.

5. The pointer system as recited in claim 4, wherein the personal computer comprises a tablet PC.

6. The pointer system as recited in claim 3, wherein the pointer comprises a digitizer pen.

7. The pointer system as recited in claim 1, wherein the pointer retention mechanism further comprises a sleeve having a holder receiving area in which the holder moves between the pointer storage location and the pointer release location.

8. The pointer system as recited in claim 7, wherein the sleeve is slidably mounted in the housing.

9. The pointer system as recited in claim 8, wherein the sleeve is spring biased toward the holder.

10. An electronic device, comprising:
a housing;
a display electrically coupled to the housing;
an electronic pointing device; and
a retention mechanism that resistively holds the electronic pointing device in both a storage position and a release position.

11. The electronic device as recited in claim 10, wherein the retention mechanism comprises a holder slidably mounted in a sleeve, the holder having a retention feature to resist separation of the electronic pointing device.

12. The electronic device as recited in claim 11, wherein the sleeve comprises a capture feature to resistively maintain the holder and the electronic pointing device in the storage position until a sufficient removal force is applied to the electronic pointing device.

13. The electronic device as recited in claim 12, wherein the holder is spring biased towards the release position.

14. The electronic device as recited in claim 13, wherein the housing comprises a portable computer housing.

15. The electronic device as recited in claim 13, wherein the housing comprises a tablet PC housing.

16. The electronic device as recited in claim 13, wherein the housing comprises a personal digital assistant housing.

17. The electronic device as recited in claim 13, wherein the display is removable from the housing.

18. The electronic device as recited in claim 13, wherein the sleeve is spring biased towards the storage position.

19. A method of protecting a pointing mechanism utilized with an electronic device, comprising:
inserting the pointing mechanism into a holder disposed in a housing of the electronic device;
holding the pointing mechanism in the holder; and
moving the holder between a release position and a storage position.

20. The method as recited in claim 19, wherein holding comprises resistively hold the pointing mechanism with a catch.

21. The method as recited in claim 20, wherein moving comprises resistively capturing the holder at the storage position.

22. The method as recited in claim 21, wherein inserting comprises inserting an electronic pointing mechanism.

23. The method as recited in claim 19, wherein inserting comprises inserting an electronic pointing mechanism.

24. The method as recited in claim 19, wherein inserting comprises inserting the pointing mechanism into a computer housing.

25. The method as recited in claim 19, wherein inserting comprises inserting the pointing mechanism into a tablet PC housing.

26. The method as recited in claim 19, further comprising releasing the holder by pressing the pointing mechanism further into the housing.

27. The method as recited in claim 26, further comprising removing the pointing mechanism by pulling the pointing mechanism away from the housing with sufficient force to overcome the resistance to removal from the holder.

28. The method as recited in claim 19, further comprising securing the holder in a movable sleeve.

29. A method of utilizing an electronic pointing mechanism stored in an opening formed in an electronic device, comprising:
securing the electronic pointer mechanism in the electronic device;
biasing the electronic pointer mechanism towards a release position; and
selectively maintaining the electronic pointer mechanism at a storage position such that sufficient inward movement of the electronic pointer mechanism permits outward movement of the electronic pointer mechanism to the release position.

30. The method as recited in claim 29, wherein selectively maintaining comprises capturing the electronic pointer mechanism with a holder.

31. The method as recited in claim 30, wherein capturing comprises holding the electronic pointer mechanism with a mechanical catch.

32. The method as recited in claim 31, wherein biasing comprises applying a spring bias against the holder.

33. The method as recited in claim 32, wherein securing comprises securing the electronic pointer mechanism in a tablet PC.

34. A system for storing and releasing a pointer mechanism for an electronic device, comprising:
means for holding the pointer mechanism in the electronic device;
means for selectively securing the pointer mechanism at an extended release position and a retracted storage position; and
means for moving the pointer mechanism from the retracted storage position to the extended release position.

35. The system as recited in claim 34, wherein the means for moving comprises a spring.

36. The system as recited in claim 34, wherein the means for holding comprises an opening in a housing of the electronic device.

37. The system as recited in claim 34, wherein the means for selectively securing comprises a mechanical catch.
